(19) United States
(12) Patent Application Publication
(10) Pub. No.: US 2024/0220643 A1
(43) Pub. Date: Jul. 4, 2024

(54) Receiver Preventing Stall Conditions in a Transmitter While Maintaining Compatibility and Method Therefore

(71) Applicant: KONINKLIJKE PHILIPS N.V., EINDHOVEN (NL)

(72) Inventor: Rene Debets, Hoensbroek (NL)

(21) Appl. No.: 18/563,550

(22) PCT Filed: May 24, 2022
(86) PCT No.: PCT/EP2022/064054

§ 371 Date: Nov. 22, 2023

Related U.S. Application Data
(60) Provisional application No. 63/194,174, filed on May 27, 2021.

(51) Int. Cl. G06F 21/60

(52) U.S. Cl. CPC G06F 21/606; G06F 2221/2103

(57) ABSTRACT

A receiver that is arranged to receive protected content from a variety of transmitters, some of the transmitters imposing a maximum response time between sending a challenge to the receiver and receiving a response from the receiver while other transmitters lack such a requirement, it is necessary that receivers remain compatible with both systems. To achieve this such a receiver is arranged to receive protected content from a transmitter, the transmitter sending a challenge to the receiver and receiving a response from the receiver, the receiver comprising a processor, the processor configured to execute some or all of a challenge response generator, a communication receiver, the communication receiver configured to receive a challenge from the transmitter, and a communication transmitter, the communication transmitter configured to return a response to the transmitter, the challenge response generator being arranged to receive the challenge from the communication receiver and to generate a response and to transmit the response to the communication transmitter for return to the transmitter after a response delay, wherein the processor is configured to select in response to a challenge one of a first response and a second response: where the first response is a valid response to be provided after a first response delay and where the second response it an invalid response to be provided after a second response delay, and where the second response delay is longer than the first response delay. By providing valid responses with short response times as well as invalid responses with long response times compatibility with legacy transmitters is ensured while at the same time ensuring that receivers that lack means guarding against stalls in the challenge response procedure will be caused to reinitialize by an invalid response.

### TECHNICAL FIELD OF THE INVENTION

The invention relates to a receiver arranged to receive protected content from a transmitter, the transmitter sending a challenge to the receiver and receiving a response from the receiver, the receiver comprising a processor, the processor comprising a challenge response generator, a communication receiver for receiving a challenge from the transmitter and a communication transmitter for returning a response to the transmitter the challenge response generator being arranged to receive the challenge from the communication receiver and to generate a response and to transmit the response to the communication transmitter after a response delay time.

### BACKGROUND ART

Such a receiver is known from the Digital Content Protection LLC proprietary specification called HDCP 2.3 edition 2018 which is available from https://www.digital-cp.com/. In HDCP 2.3 a locality check is performed which imposes a maximum response delay time between sending a challenge to the receiver and receiving a response from the receiver.

A random number Rn is generated by the transmitter and sent to the receiver.

The receiver generates a response based on the challenge, in the case of HDCP 2.3 this challenge is a modification of the random number Rn based on a shared secret that has previously been shared by the transmitter and the receiver. The Receiver thus proves that it is in possession of the shared secret and that the response to the challenge really originated from the same receiver as the secret was shared with. The random number Rn is later used in the establishment of a secure authenticated channel.

By imposing a time limit the transmitter complying with the 2018 HDCP 2.3 ensures that the receiver is local.

This locality check is in view of the technological developments and distribution of content via other channels that do not impose such a requirement on the location of the receiver no longer needed. Imposing a maximum response delay time is thus no longer a useful requirement and has been dropped.

These updated transmitters however create a problem with a large installed base of transmitters and receivers as well as with updated receivers losing compatibility with the installed base of legacy transmitters.

When a updated receiver that no longer functions in a way that it provides the response to the challenge in time for transmitter still imposing the maximum response time requirement, the transmitter will determine a failure of the locality check and will not provide the content. This results in customer frustration.

Also, on the transmitter side, no longer having any requirement as to when a response to the challenge the transmitter sent has to be received result in system that stalls and will never recover. As such also a transmitter without a time based locality check will still have to require a maximum response delay time after which the locality check is deemed to have failed and a new locality check using a new Rn challenge can be initiated. However some updated transmitters lack this time check and thus will never time out. This causes frustration with customers.

### DISCLOSURE OF THE INVENTION

In order to overcome these problems the wherein the processor is configured to select in response to a challenge one of a first response and a second response, where the first response is a valid response to be provided after a first response delay and where the second response it an invalid response to be provided after a second response delay, and where the second response delay is longer than the first response delay.

This choice for the receiver according to the invention of a valid response with a response delay that satisfied the timing requirements imposed by legacy transmitters and an invalid response that does not satisfied the timing requirements imposed by legacy transmitters allows the receiver according to the invention to properly work with both legacy transmitters and updated transmitters, yet the invalid response with the second, longer response delay ensures that updated transmitters that lack the time out will be forced to retry the challenge response procedure solely based on the invalid response received, thus avoiding a stall in the updated receiver.

For legacy transmitters, for instance those that comply with the 2018 HDCP 2.3 specification, and thus require a short response delay time, the valid first response with associated response time.

For updated transmitters that no longer use a time requirement in the locality check and are at the risk of stalling in the challenge response procedure the second invalid response will ensure continuation of the challenge response procedure while such a second response causes no issues with a legacy transmitter beyond that the legacy transmitter will have to retry the challenge response procedure.

The receiver can either alternate the first and second responses as responses to successive challenges, or the receiver can send a second response if no protected data is being received from the updated transmitter which could be caused by a stall of the updated transmitter in the challenge response procedure.

This way a receiver functions properly without risk of stalls with updated transmitters while maintaining compatibility with legacy transmitters.

In an embodiment the second response delay exceeds a legacy transmitter's decision criterium while the first response delay does not exceed the legacy transmitter's decision criterium.

By selecting a second response delay that exceeds the legacy transmitter's decision criterium it is ensured that the legacy transmitter's decision criterium is based on validity of the response and not on a late arrival of the response. Late arrivals of valid or invalid responses are of no use to the legacy transmitter as there is a predetermined time limit that has to be met by timely arrival of the response. As the updated transmitter does not have such a predermined time as a limit an invalid response arriving late would ensure that the updated transmitter retries (i.e. re-initiates) the challenge response procedure, thus terminating the stall situation which otherwise would have led to dissatisfied customers.

In an embodiment the second response delay is chosen from a range of response delays, all exceeding the legacy transmitter's decision criterium.

Late arrivals of valid or invalid responses are of no use to the legacy transmitter as there is a predetermined time limit that has to be met by timely arrival of the response. It doesn't matter how much later the response arrives as legacy transmitters have a fixed hard predetermined limt limit. As the updated transmitter does not have such a predermined time as a limit any invalid response arriving arbitrarily late would still ensure that the updated transmitter retries (i.e. re-initiates) the challenge response procedure. As the function of this second response is to have an updated transmitter reinitiate the challenge response procedure the second response delay can be chosen from a range, as second response delays exceed the predetermine time limit of legacy transmitters.

In an embodiment the legacy transmitter's decision criterium determines whether protected content is provide to the receiver.

The legacy transmitter uses a challenge response procedure to determine, next to other criteria, whether protected content is to be provided to the receiver. If the receiver of the present invention would not be able to satisfy this criterium protected content would not be provided by legacy transmitters leading to dissatisfied customers.

The method according t the invention has similar advantages based on corresponding method steps.

### BRIEF DESCRIPTION OF THE DRAWINGS

FIG. 1 shows a legacy transmitter and a legacy receiver.

FIG. 2 shows an updated transmitter and an updated receiver.

FIG. 3 shows a timing diagram of a legacy locality check.

FIG. 4 shows a timing diagram of an updated locality check.

FIG. 5 shows a receiver according to the invention.

FIG. 6 shows a timing diagram of a locality check between a legacy transmitter and a receiver according to the invention.

FIG. 7 shows a timing diagram of a locality check between an updated transmitter and a receiver according to the invention.

FIG. 8 shows the steps of a receiver method according to the invention.

### MODES FOR CARRYING OUT THE INVENTION

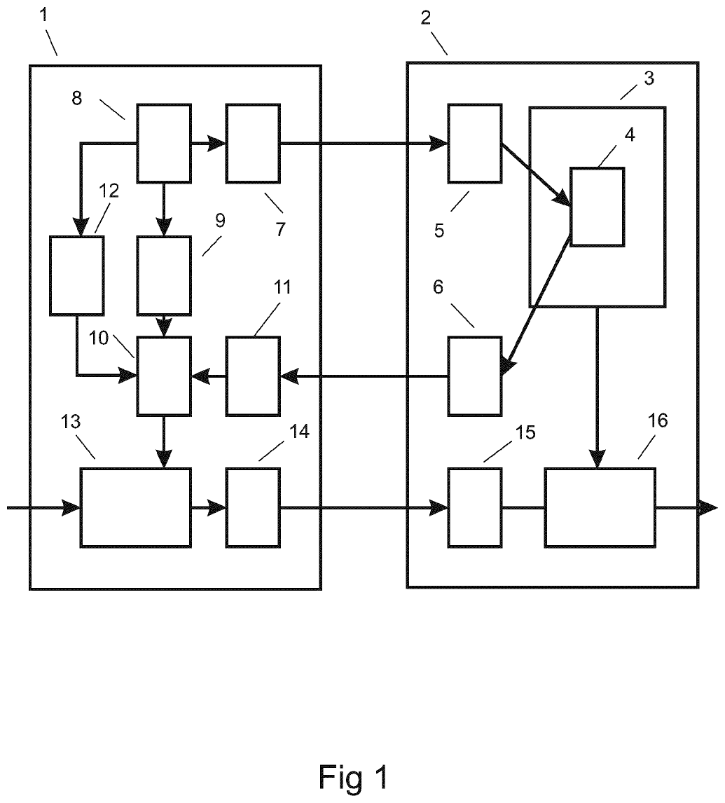

FIG. 1 shows a legacy transmitter and a legacy receiver.

A legacy receiver 2 is arranged to receive protected content from a legacy transmitter 1, the legacy transmitter 1 imposing a maximum response delay time between sending a challenge to the legacy receiver 2 and receiving a response from the legacy receiver 2.

In order to be able to provide a response to the challenge the legacy receiver 2 comprises a processor 3. This processor can be a general purpose processor with associated circuitry to control the receiver or can be, again with the required external circuitry, be arranged to control the challenge response process.

The processor comprises a challenge response generator 4. This challenge response generator 4 receives from the receiver's communication receiver circuit 5 the challenge as transmitted by the transmitter 1 using a transmitter's communication transmission circuit 7 to transmit a random number as generated by a random number generator 8 which is also comprised in the transmitter 1.

After receiving the challenge the challenge response generator 4 calculates a response. This response can for instance be a modification of the challenge received using a secret that is shared known to both transmitter 1 and receiver 2. This calculation takes a certain amount of time, after which the challenge response generator provides the response to the receiver's transmission communication circuit 6, which in turn transmits the response to the legacy transmitter 1. The legacy tranmitter 1 receives the response via transmitter's communication receiving circuit 11. While the challenge was sent to the legacy receiver 2, the legacy transmitter performed the same calculation as the legacy receiver's 2 challenge response unit 4. The result of this local calculation performed in the legacy transmitter is provided just as well as the received response to a locality verification unit 10. This locality verification unit 10 performs two functions. It verifies that the locally calculated result is equal to the received response and that the received response was received within a predetermined time. A timer 12 provides timing information to the locality verification unit 10. The timer is started when the challenge is transmitted by the legacy transmitter 1 and is either stopped of compared against when the response has been received by the legacy transmitter 1.

If both conditions are met the locality verification unit 10 enables the provision of protected content by the legacy transmitter 1 to the legacy receiver 2.

To this end the protected content is received by the transmitter 1 and encrypted by an encryptor 13. After encryption the protected content is transmitted to the receiver using the transmitter's content transmitter circuitry 14. The receiver 2 where it is received by the receiver's content receiver circuitry 15 which in turn provides the protected content to a decryptor 16 where the protected content is decrypted for further use.

As the challenge can comprise a random number, this random number can be used during encryption and decryption of the protected content.

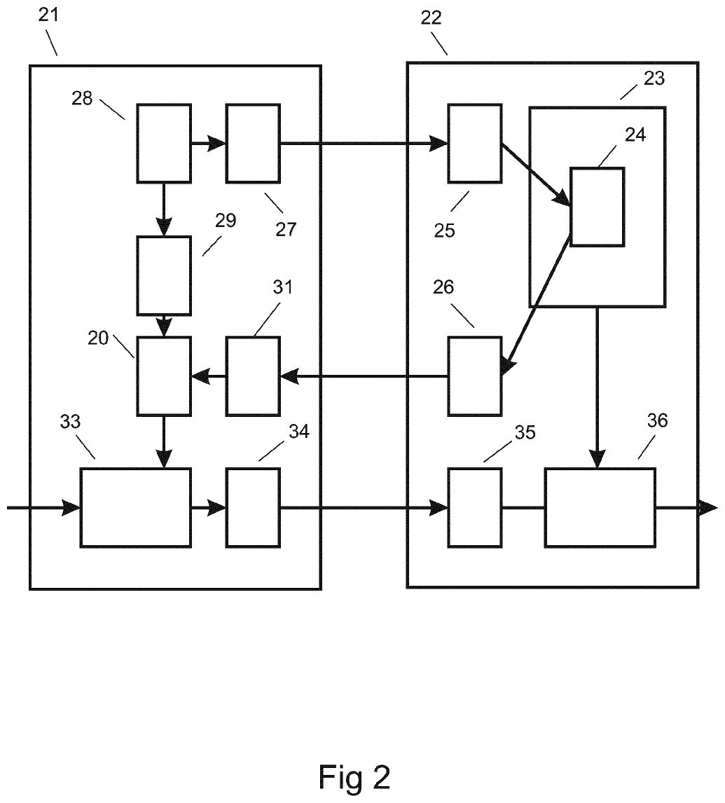

FIG. 2 shows a updated transmitter and an updated receiver.

An updated receiver 22 is arranged to receive protected content from a updated transmitter 1, the updated transmitter 21 imposing a maximum response delay time between sending a challenge to the updated receiver 22 and receiving a response from the updated receiver 22.

In order to be able to provide a response to the challenge the updated receiver 22 comprises a processor 3. This processor can be a general purpose processor with associated circuitry to control the receiver or can be, again with the required external circuitry, be arranged to control the challenge response process.

The processor comprises a challenge response generator 24. This challenge response generator 24 receives from the receiver's communication receiver circuit 25 the challenge as transmitted by the transmitter 21 using a transmitter's communication transmission circuit 27 to transmit a random number as generated by a random number generator 28 which is also comprised in the transmitter 21.

After receiving the challenge the challenge response generator 4 calculates a response. This response can for instance be a modification of the challenge received using a secret that is shared known to both transmitter 21 and receiver 22. This calculation takes a certain amount of time, after which the challenge response generator provides the response to the receiver's transmission communication circuit 26, which in turn transmits the response to the updated transmitter 21. The updated tranmitter 21 receives the response via transmitter's communication receiving circuit 11. While the challenge was sent to the updated receiver 22, the updated transmitter performed the same calculation as the updated receiver's 22 challenge response unit 24. The result of this local calculation performed in the updated transmitter is a locally generated response that is then provided just as well as the received response to a locality verification unit 30. This locality verification unit 30 performs a single function. It verifies that the locally calculated response is equal to the received response and does not check that the received response was received within a predetermined time. As such the locality verification unit will not time out. The operation of the transmitter 21 will stall in this state which leads to dissatisfaction by the user as the transmitter now has to be reset.

If a correct response has been received the locality verification unit 30 enables the provision of protected content by the updated transmitter 21 to the updated receiver 22.

To this end the protected content is received by the transmitter 21 and encrypted by an encryptor 33. After encryption the protected content is transmitted to the receiver using the transmitter's content transmitter circuitry 34. The receiver 22 where it is received by the receiver's content receiver circuitry 35 which in turn provides the protected content to a decryptor 36 where the protected content is decrypted for further use.

If however the updated transmitter 21 stalls for any reason during the challenge response procedure the protected content will not be provided to the updated receiver 22.

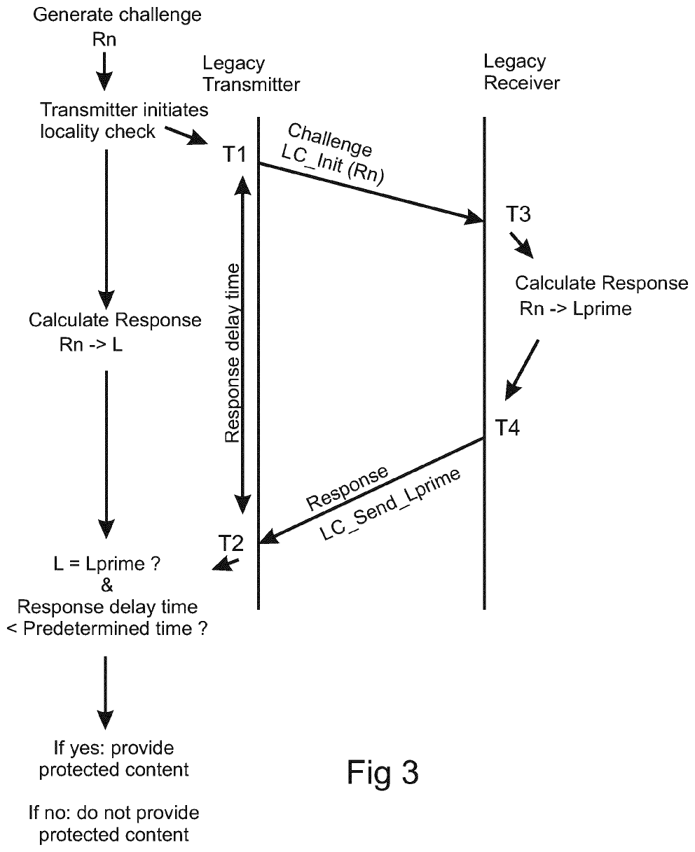

FIG. 3 shows a timing diagram of a legacy locality check.

FIG. 3 shows the behavior of the legacy transmitter on the left and the legacy receiver on the right.

The transmitter first generates a challenge, for instance a random number Rn, and at time T1 transmits this challenge to the receiver, for instance using the command LC_INIT comprising the Random number Rn. This challenge is received by the receiver at time T3 and the receiver's challenge response generator starts calculating a response. This response can for instance be a modification of the random number Rn using a secret that previously had been shared between the transmitter and the receiver. In parallel the transmitter will generate a local response by performing the same calculations as the receiver's challenge response generator. As soon as the receiver's challenge response generator has calculated the response this response is sent to the transmitter indicated by time T4 in FIG. 3. After the transmitter receives the response at time T2, for instance via LC_Send_Lprime, it compares the received response to the locally generated response. In addition the locality verification unit will check whether the response was received within the predetermined time limit. i.e. whether T2-T1<predetermined time limit. If the locally generated response and received response are identical, and the response was received within the predetermined time limit, the transmitter continues and provides the protected content to the receiver. If the locally generated response and received response are not identical and/or the predetermined time has been exceeded, the transmitter retries the locality check by generating a new Rn and sending it a new challenge to the receiver. It will in this case not provide the protected content to the receiver. If no response is received the system will time out based on the predetermined time and a new challenge is sent to the receiver. For a complete description of such a legacy system the document “High bandwidth Digital Content Protection System. Mapping HDCP to HDMI, Revision 2.3 Dated 28 Feb. 2018, section 2.3 Locality check on pages 16 and 17 is included by reference.

As a result, the legacy transmitter will not stall because no response has been received.

Any late received responses are ignored as a new challenge response procedure is initiated after the expiry of the predetermined time limit. The legacy transmitter will perform 1024 retries before finally failing. Thus a low number of invalid responses that are received after the expiry of the predetermined time limit will not significantly delay the provision of the content to the receiver.

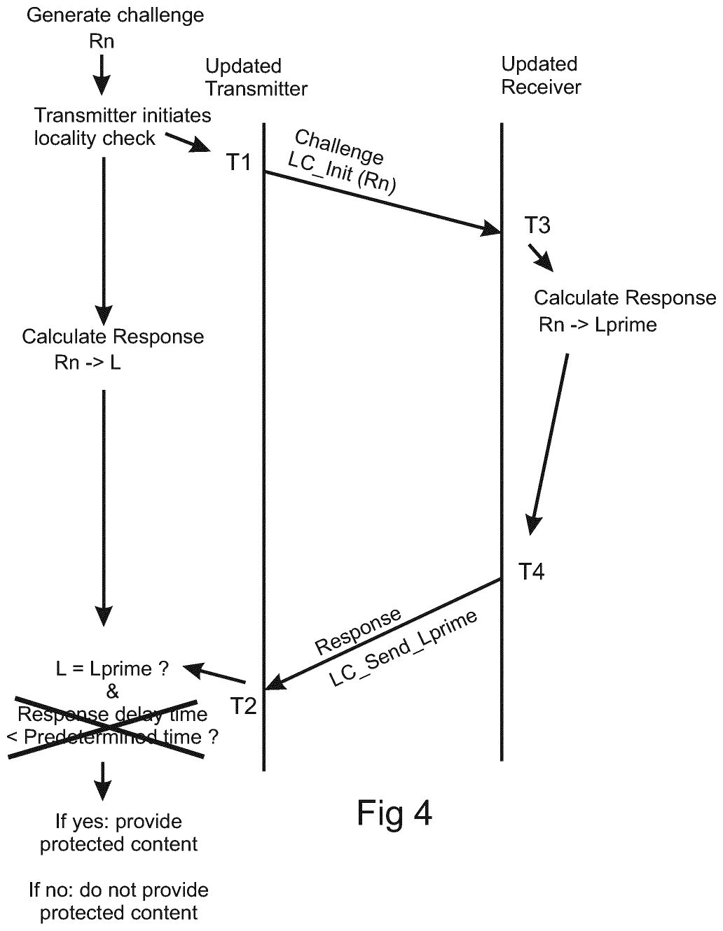

FIG. 4 shows a timing diagram of an updated locality check.

FIG. 4 shows the behavior of the updated transmitter on the left and the updated receiver on the right.

The transmitter first generates a challenge, for instance a random number Rn, and at time T1 transmits this challenge to the receiver, for instance using the command LC_INIT comprising the Random number Rn. This challenge is received by the receiver at time T3 and the receiver's challenge response generator starts calculating a response. This response can for instance be a modification of the random number Rn using a secret that previously had been shared between the transmitter and the receiver. In parallel the transmitter will generate a local response by performing the same calculations as the receiver's challenge response generator. As soon as the receiver's challenge response generator has calculated the response this response is sent to the transmitter indicated by time T4 in FIG. 4. After the transmitter receives the response it compares the received response to the locally generated response. If the locally generated response and received response are identical the transmitter continues and provides the protected content to the receiver. If the locally generated response and received response are not identical the transmitter retries the locality check by generating a new Rn and sending it a new challenge to the receiver. It will in this case not provide the protected content to the receiver. If no response is received the system will stall as the predetermined time is not checked anymore. In this configuration the receiving time of the response by the transmitter T2 is of no importance anymore, allowing relaxed processing times to calculate the response from the challenge but introducing problems in the form of a system that might stall in the state of waiting for a response from the receiver as no internal time-out exists.

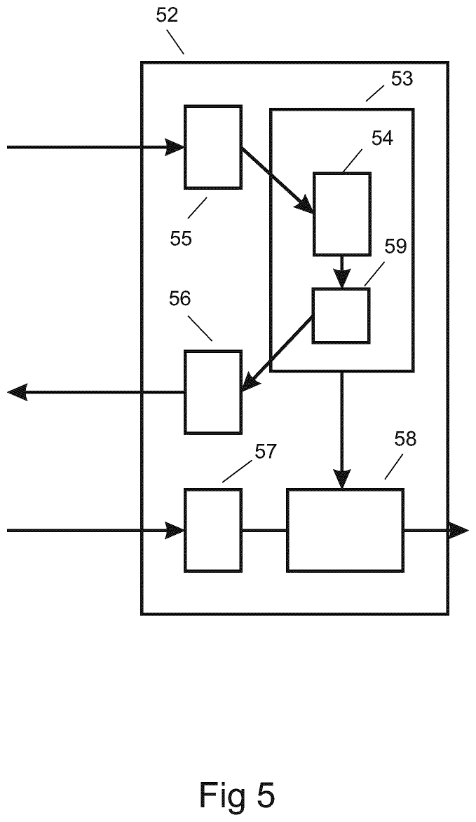

FIG. 5 shows a receiver according to the invention.

An receiver 52 according to the invention is arranged to receive protected content from a transmitter (not shown), updated or legacy, some transmitters imposing a maximum response delay time between sending a challenge to the receiver 52 according to the invention and receiving a response from the receiver 52 according to the invention while other transmitters don't impose such a predetermined time limit.

In order to be able to provide a response to the challenge the receiver 52 comprises a processor 53. This processor can be a general purpose processor with associated circuitry to control the receiver or can be, again with the required external circuitry, be arranged to control the challenge response process.

The processor 53 comprises a challenge response generator 54. This challenge response generator 54 receives from the receiver's communication receiver circuit 55 the challenge as transmitted by the transmitter the challenge for instance comprising a random number.

After receiving the challenge the challenge response generator 54 calculates a response. This response can for instance be a modification of the challenge received using a secret that is shared known to both transmitter and receiver 52. The processor 53 can however also cause the challenge response generator 54 to generate an invalid response, for instance by providing an incorrect challenge instead of the received challenge or by replacing a correct response as produced by the challenge response generator 54 by an incorrect response, for example a fixed value. The valid respectively the invalid response is subsequently provided to a response delay control unit 59. This response delay control unit selects a delay from a range of delays. For a valid response the response delay control unit 59 selects a first response delay and for an invalid response the response delay control unit 59 selects a second response delay. The second response delay can be for instance be chosen to exceed a legacy transmitter's decision criterium while the first response delay is chosen to not exceed the legacy transmitter's decision criterium. The second response delay can advantageously chosen from a range of response delays, all exceeding the legacy transmitter's decision criterium. The legacy transmitter's decision criterium determines whether protected content is provide to the receiver.

The response delay control unit 59 then provides the response to the receiver's transmission communication circuit 56, which in turn transmits the response to the transmitter. The tranmitter receives the response via transmitter's communication receiving circuit. While the challenge was sent to the receiver 52, the updated transmitter performed the same calculation as the receiver's 52 challenge response unit 54. The result of this local calculation performed in the transmitter is a locally generated response that is then provided just as well as the received response to a locality verification unit. This locality verification unit either only verifies that the locally calculated response is equal to the received response and does not check that the received response was received within a predetermined time or it verifies that the locally calculated response is equal to the received response and additionally does check that the received response was received within a predetermined time. Based on the verification performed by locality verification unit the protected content is then provided by the transmitter to the receiver 52 where it is received by the receiver's content receiver 57 which in turn provides the protected content to a decryptor 58 where the protected content is decrypted for further use.

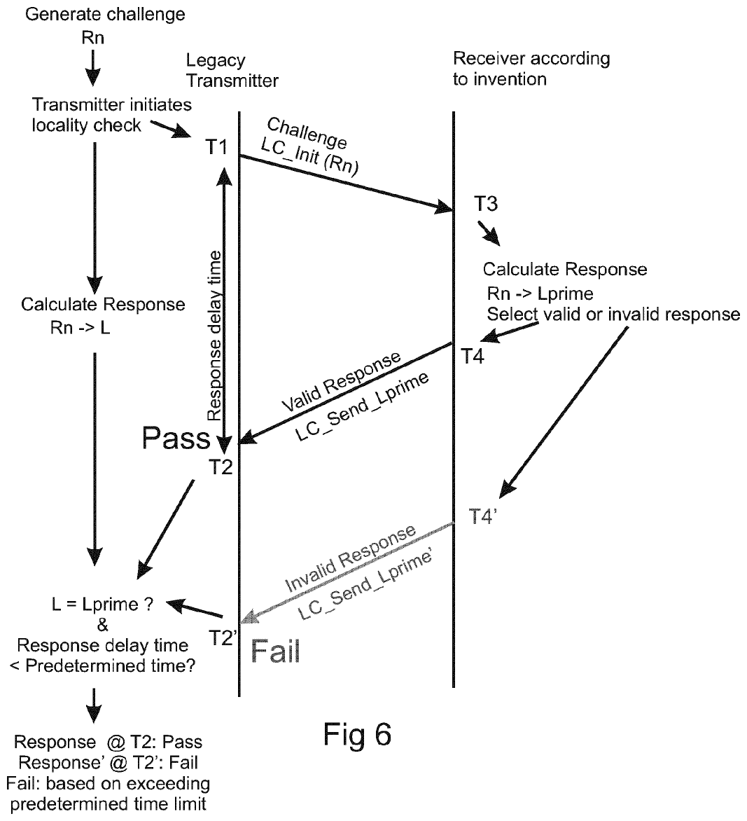

FIG. 6 shows a timing diagram of a locality check between a legacy transmitter and a receiver according to the invention.

FIG. 6 shows the behavior of the legacy transmitter on the left and a receiver according to the invention on the right.

The transmitter first generates a challenge, for instance a random number Rn, and at time T1 transmits this challenge to the receiver according to the invention, for instance using the command LC_INIT comprising the Random number Rn. This challenge is received by the receiver at time T3 and the receiver's challenge response generator starts calculating a response. This response can for instance be a modification of the random number Rn using a secret that previously has been shared between the transmitter and the receiver. In parallel the transmitter will generate a local response by performing the same calculations as the receiver's challenge response generator. The receiver's challenge response generator calculates the response. Compared to the previous examples the receiver according to the invention however now can select between two responses and associated response delay times. A valid response with a first, short, response delay time is sent back to the transmitter at T4, resulting in a response delay time T2-T1 as measured by the transmitter that is shorter than the predetermined time limit. The receiver according to the invention can however also chose an invalid response with an associated second, longer, response delay time. This second response delay time preferably exceeds the predetermined time limit of legacy transmitters so as to ensure that when sent at time T4′ the invalid response arrives at time T2′ after expiry of the predetermined time limit at the transmitter, thus allow in legacy transmitters to reinitiate the challenge response based on this predetermined time limit expiry instead of based on an invalid response. The invalid responses arriving late at a legacy transmitter will result in the legacy transmitter retrying by sending another challenge and there fore not stall the transmitter. Valid responses with a shorter response delay time will arrive in time at time T2 at the legacy transmitter to satisfy the predetermined time limit as imposed by HDCP 2.3 and protected content can be provided. It is no problem that the legacy transmitter has to retry as it introduces minimal delay in the start of providing protected content. When the transmitter receives the response, for instance using the command LC_Send_Lprime, it compares the received response to the locally generated response. If the locally generated response and received response are identical the transmitter continues and provides the protected content to the receiver. If the locally generated response and received response are not identical and/or the predetermined time has been exceeded, the transmitter retries the locality check by generating a new Rn and sending it a new challenge to the receiver. It will in this case not provide the protected content to the receiver.

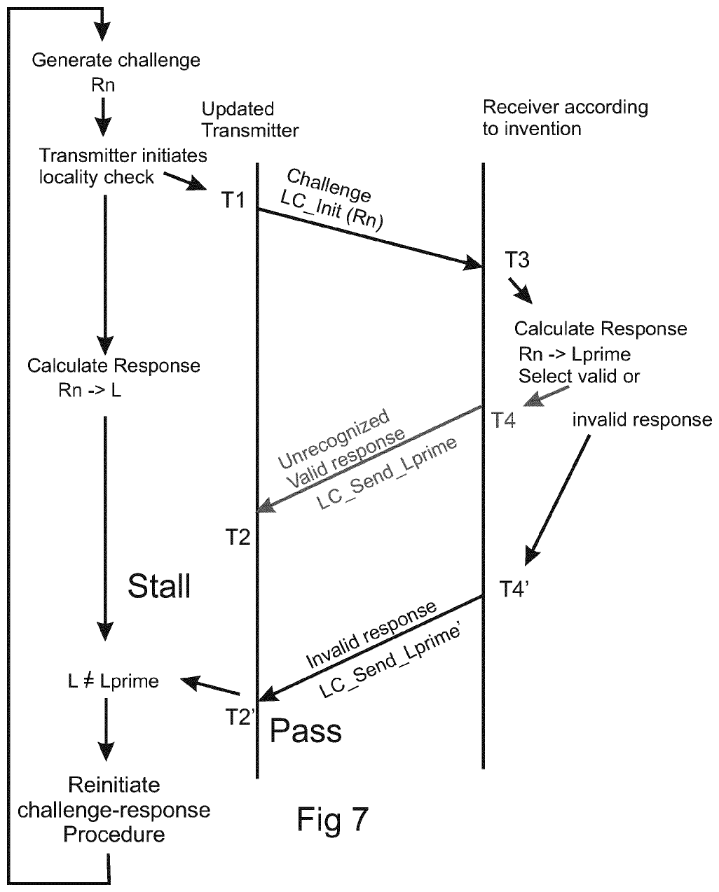

FIG. 7 shows a timing diagram of a locality check between an updated transmitter and a receiver according to the invention.

FIG. 7 shows the behavior of the updated transmitter on the left and receiver according to the invention on the right.

The transmitter first generates a challenge, for instance a random number Rn, and at time T1 transmits this challenge to the receiver, for instance using the command LC_INIT comprising the Random number Rn. This challenge is received by the receiver at time T3 and the receiver's challenge response generator starts calculating a response. This response can for instance be a modification of the random number Rn using a secret that previously had been shared between the transmitter and the receiver. In parallel the transmitter will generate a local response by performing the same calculations as the receiver's challenge response generator. The receiver's challenge response generator calculates the response. Compared to the previous examples the updated transmitter will remain waiting for a response, effectively stalling the challenge response procedure. Now, if the updated transmitter does not recognize a response such as the unrecognized response send at T4 and shown in grey in FIG. 7, or no response at all is received from the receiver, the stall will continue as no response is received and the transmitter will not reinitialize a new challenge response procedure by itself like a legacy transmitter would do.

To safeguard against this situation the receiver according to the invention can send a second, invalid response the response at time T4′ so as to ensure that the updated transmitter reinitializes the challenge response procedure and a new challenge is sent so that the receiver can calculate and provide the appropriate correct response. The response delay control unit is used to delay the response when the response to be provided is an invalid response. When a valid response is to be provided no delay or a short delay is used.

When the updated transmitter receives a response it compares the received response to the locally generated response. If the locally generated response and received response are identical the transmitter continues and provides the protected content to the receiver. If the locally generated response and received response are not identical, the transmitter reinitializes the locality check by generating a new Rn and sending it a new challenge to the receiver. It will in this case not provide the protected content to the receiver until a valid response has been received. As the updated transmitter does not impose a predetermined time limit a later received response still will allow the updated transmitter to provide the protected content.

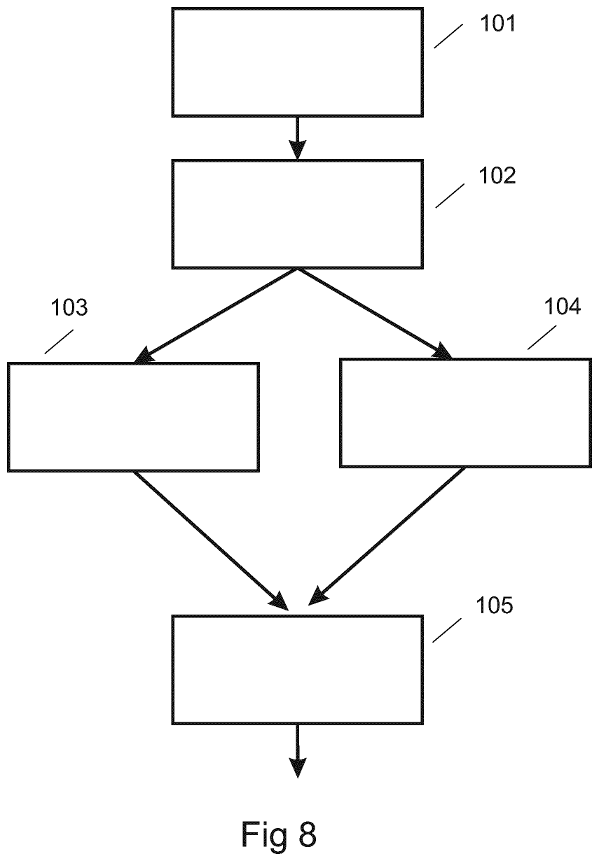

FIG. 8 shows the steps of a receiver method according to the invention.

FIG. 8 shows a method to receive protected content from a transmitter, the transmitter imposing a maximum response delay time between sending a challenge and receiving a response,
the method comprising the steps of:
   receiving 101 a challenge from the transmitter,
   generating 102 a response: and
   transmitting 105 the response to transmitter after a response delay time,
the method further comprising the step of
   controlling 103, 104 the response delay time
the method further comprising the step of:
   selecting 102 in response to a challenge one of a first response and a second response:
where the first response is a valid response to be provided after a first response delay, and
where the second response it an invalid response to be provided after a second response delay,
and where the second response delay is longer than the first response delay.

In the step of controlling the response delay time 103, 104 a first valid response is associated with a first response delay time and a second invalid response is associated with a second response delay time, the first and second response delay times differing from each other.

In step 102 either the first valid response or the second invalid response is chosen. This choice can be based on a predetermined or random pattern or upon the detection of a stall condition of the tranmitter by the receiver according tot the invention for instance by detecting that after providing a response the protected content is not being provided, or other parts of a procedure necessary to enable the providing of the protected content not being executed by the transmitter.

After selecting either a first valid response or a second invalid response a response delay time is selected. If a first valid response has been selected in step 102 a short (or no) response delay is introduced in delay step 103. If however a second invalid response has been selected in step 102 a long response delay is introduced in delay step 104. The advantages of this have been detailed in the description of the receiver and will not be repeated here for conciseness reasons.

After the introduction of the appropriate delay in steps 103 or 104 the response (valid or invalid) is transmitted 105 to the transmitter. If the transmitter was stalled the second invalid response will cause the transmitter to reinitialize the challenge response procedure. If a second response is received by a legacy transmitter the legacy transmitter will reinitialize or have reinitialized the challenge response and the response will be ignored.

It is to be noted that when this application uses the words first and second response this does not refer to a sequence and a successiveness of the responses but merely is used to refer to the tupes of responses. The responses can be sent in any sequence. Both updated and legacy transmitters will however, at the expense of an occasional failure of the challenge response procedure, enjoy compatibility with receiver according to the invention.

### DEFINITION OF TERMS

In this description the following terms mean the following:

Legacy transmitter: a transmitter adhering to an earlier specification.

Legacy receiver: a receiver adhering to an earlier specification.

Updated transmitter: a transmitter adhering to a later version of the earlier specification or adhering to an errata of such an earlier specification.

Updated receiver: a receiver adhering to a later version of the earlier specification or adhering to an errata of such an earlier specification.

It is further to be noted that a receiver according to the invention has been described using the HDCP specification because this specification is well understood by the person skilled in the art and publicly available. This does however not imply that this invention is limited to this specification. Other data transmission specifications have locality checks that impose a time constraint on the response to a challenge and the present invention can be used for receivers for these specifications as well.

1. A receiver comprising:
a processor circuit;
a communication receiver circuit, wherein the communication receiver circuit is arranged to receive a challenge from a transmitter; and
a communication transmitter circuit, wherein the communication transmitter circuit is arranged to return a response to the transmitter,
wherein the processor circuit is arranged to receive the challenge from the communication receiver circuit,
wherein the processor circuit is arranged to generate the response,
wherein the processor circuit is arranged to send the response to the communication transmitter circuit after a response delay,
wherein the processor circuit is arranged to select one of a first response and a second response,
wherein the first response is sent after a first response delay,
wherein the second response is sent after a second response delay,
wherein the second response delay is longer than the first response delay.

2. The receiver as claimed in claim 1,
wherein the second response delay is greater than a legacy transmitter's decision criterium,
wherein the first response delay is less than or equal to the legacy transmitter's decision criterium.

3. The receiver as claimed in claim 2, wherein the second response delay is chosen from a range of response delays.

4. The receiver as claimed in claim 2, wherein the legacy transmitter's decision criterium determines whether protected content is provide to the receiver.

5. A method comprising:
receiving a challenge from a transmitter,
generating a response;
transmitting the response to transmitter after a response delay time;
controlling the response delay time; and
selecting one of a first response and a second response in response to the challenge,
wherein the first response is sent after a first response delay, and
wherein the second response is a sent after a second response delay,
wherein the second response delay is longer than the first response delay.

6. The method as claimed in claim 5,
wherein the second response delay is greater than a legacy transmitter's decision criterium,
wherein the first response delay is less than or equal to the legacy transmitter's decision criterium.

7. The method as claimed in claim 6, wherein the second response delay is chosen from a range of response delays.

8. The method as claimed in claim 6, wherein the legacy transmitter's decision criterium determines whether protected content is provide to.

9. The computer program stored on a non-transitory medium, wherein the computer program when executed on a processor performs the method as claimed in claim 5.

10. (canceled)

11. The receiver as claimed in claim 1, wherein the first response is a valid response.

12. The receiver as claimed in claim 1, wherein the second response is an invalid response.

13. The method as claimed in claim 5, wherein the first response is a valid response.

14. The method as claimed in claim 5, wherein the second response is an invalid response.
